(19) United States
(12) Patent Application Publication
(10) Pub. No.: US 2010/0193210 A1
(43) Pub. Date: Aug. 5, 2010

(54) ELASTIC CONNECTION BETWEEN HOUSING PARTS OF MOTOR-DRIVEN POWER TOOLS

(76) Inventors: Jochen Krauter, Hildrizhausen (DE); Joerg Maute, Sindelfingen (DE); Juergen Wiker, Hangzhou/Bing Jiang District Yunnan (CN)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/666,199

(22) PCT Filed: May 2, 2008
(86) PCT No.: PCT/EP2008/055409

§ 371 Date: Dec. 22, 2009

(30) Foreign Application Priority Data
Jul. 2, 2007 (DE) 102007030703.0

(51) Int. Cl. B25F 5/02; F16B 4/00

(52) U.S. Cl. 173/171; 403/291

(57) ABSTRACT

The invention relates to a rechargeable power supply device for supplying power to an electrical appliance. The rechargeable power supply device is provided with at least one chip on which data for identification of the power supply device can be stored, and can be read by the electrical appliance and/or by a charger.

The invention relates to an elastic connection between housing parts of motor-driven power tools, in particular housing parts of electrically powered handheld power tools, as generically defined by the preamble to claim 1.

### PRIOR ART

Elastic connections having an elastic connection element to corresponding peripheral regions of housing parts that is disposed spanning the gap are known in the industry and are used for the most various reasons, such as noise abatement, tolerance compensation, and/or construction simplification; depending on the intended application and on the field of use of the particular power tool, different loads on the elastic connection result, and sometimes, loads that can be mastered only conditionally by conventional structural features have to be mastered as well, requiring that a shift be made to special solutions to the problem.

### DISCLOSURE OF THE INVENTION

It is the object of the invention to embody an elastic connection of the type defined at the outset in such a way that, regardless of its heavy load-bearing capability, it is satisfactory both as a covering element and in damping performance and can be produced economically.

This is attained with an embodiment of the elastic connection as defined by claim 1, according to which the connecting element is attached in form-locking fashion to at least one of the housing parts to be connected, in such a way that the connecting element has a land penetrating a breach of the housing part, and this land connects covering parts of the connecting element that are located in coincidence with the breach. The result for the connecting element is a binding to the respective housing part attached in this way, whose strength is limited in the final analysis only by the strength of the material used for the connecting element and/or the load-bearing capacity of the housing part in the area around the breach.

Given a suitable binding of the connecting element to two or more housing parts, a heavy-duty connection is thus created, which in the vicinity between its peripheral portions, in which it is fixed in form-locking fashion to the peripheral regions of the housing parts, can be designed in its form to suit the given conditions and in its elasticity, damping performance and strength, and connecting elements that have peripheral portions that deviate from one another in their extension direction can even be designed.

Advantageously, the connecting element, for instance with a diaphragm-like design, can have high flexibility in its middle portion located between the peripheral portions, or may be designed with a view to strong damping of vibration. This can be attained among other things as well by providing that for the middle portion, a different material from that for the peripheral portions, or a material that is processed differently from that for those portions, is selected.

Taking into account the loads and strains acting on the connecting element and/or to be transmitted via the connecting element, and given the demands that must be met in terms of design standpoints, a covering part that is in coincidence with a breach can be formed by a respective top part, protruding past the breach and transversely to it, of the land connecting the covering parts, or one common covering strip can be associated as a covering part with a plurality of lands, and it is also within the scope of the invention to design the covering parts associated with a peripheral region differently.

The connection according to the invention can be used for housing parts whose peripheral regions extend essentially toward one another in the same plane or that are offset in steps from one another, or are at angles to one another; the breaches in the corresponding peripheral regions in their course between the covering parts in the connected housing part can be designed differently in shape and/or extent, so that in this way, various loads to be transmitted can be taken into account.

Particularly in conjunction with an arrangement of the peripheral region of a particular housing part that is angled or stepped relative to the extension plane, it is possible within the scope of the invention by way of the connecting element also to achieve a connection that is in the same plane as the housing parts but is optionally offset in fluted fashion, without impairing the other functions of the connecting element and/or the strength of the connection between the housing parts.

In particular, the embodiment of the connection in accordance with the invention is also suitable for being achieved by injection molding, and with the connection of the invention it is possible in particular to attach carrying and/or guiding parts, such as handles or the like, to housing parts, so that given a suitable design of the connecting element, the handle is uncoupled in a vibration-damping way from the housing via the connecting element. Particularly for this last purpose, an annular design of the connecting element, which in the connection between housing parts preferably has a striplike rectilinear course, proves to be practical.

Further advantages and practical embodiments can be learned from the further claims, the description of the drawings, and the drawings themselves. Shown are:

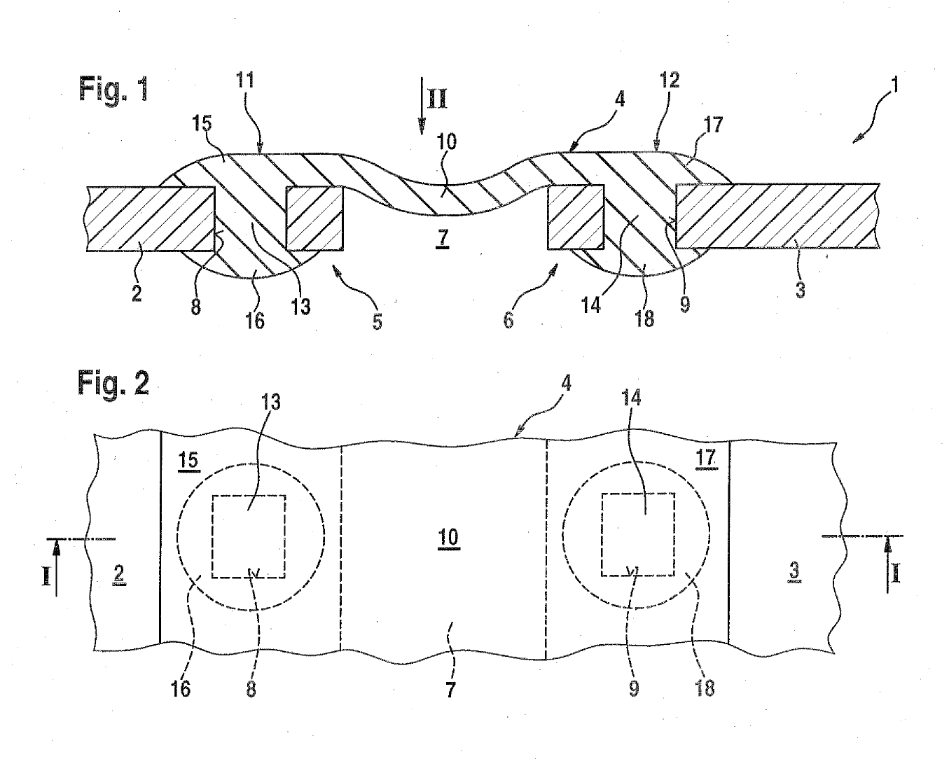

FIG. 1, a simplified, schematic cross section, in which two housing parts of a power tool are connected to one another via an elastic connection element, in accordance with the section line I-I in FIG. 2;

FIG. 2, a plan view on the illustration of FIG. 1 in the direction of the arrow II;

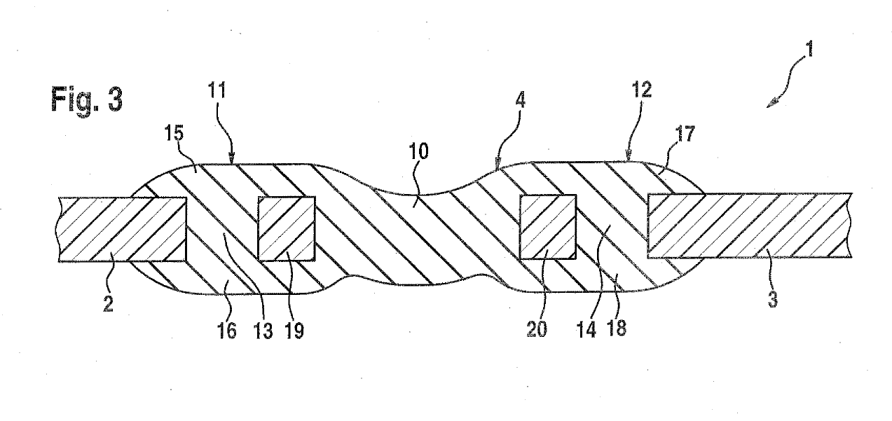

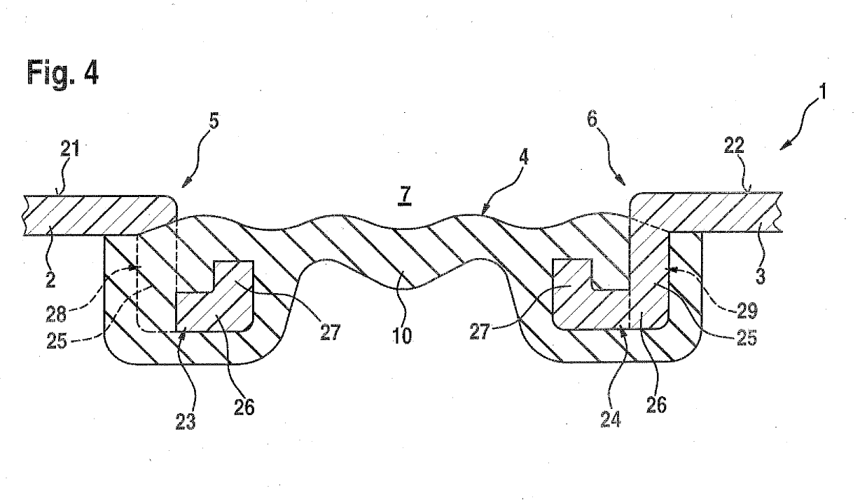

FIGS. 3 and 4, further embodiments of an elastic connection according to the invention between housing parts, in a view corresponding to FIG. 1;

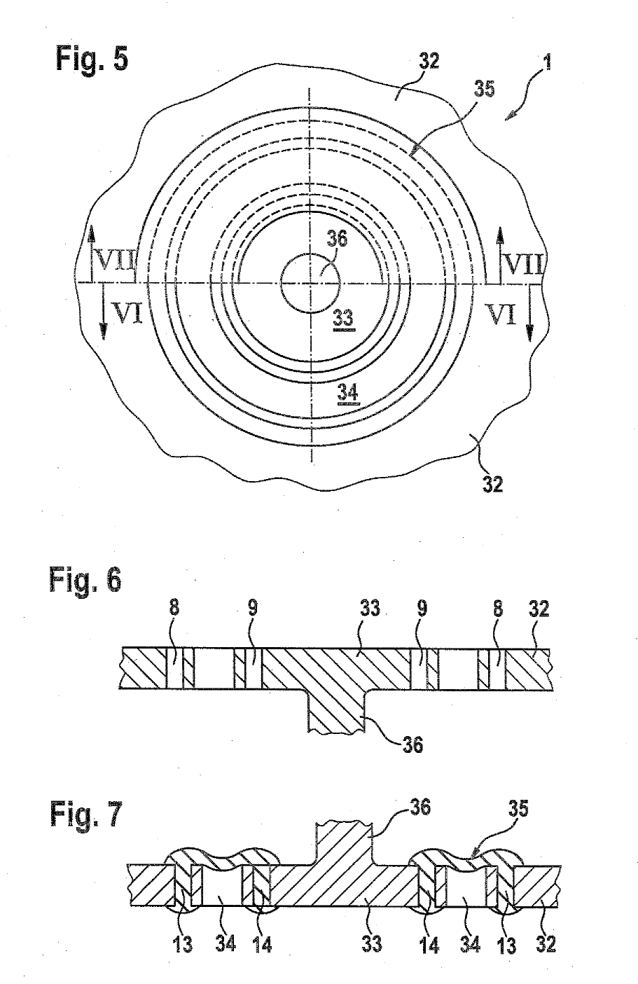

FIG. 5, in a plan view, the connection of two housing parts via an annular elastic connection element, in which one of the housing parts is connected to a handle or handhold; and

FIGS. 6 and 7, sections corresponding to the view in FIG. 5, taken along the section lines VI and VII, respectively.

Of the housing 1 of the power tool, shown here in the form of an electrically powered handheld power tool, FIG. 1 shows a fragment in which two housing parts 2 and 3 are connected to one another via a connecting element 4. The housing parts 2, 3 are shown only with regard to their adjacent peripheral regions 5, 6 extending approximately in the same direction, which are spaced apart from one another via a gap 7 and which near the periphery toward the gap 7 are provided with breaches 8, 9. The breaches 8, 9 are embodied as peripherally closed openings that penetrate the housing parts 2, 3 transversely to their extension plane. The connecting element 4 is connected to these housing parts 2 and 3 in form-locking fashion fitting over the gap 7 and with respect to the exemplary embodiment shown, it is anchored in the same way relative to housing parts 2 and 3.

The connecting element 4 has a middle portion 10, fitting over the gap 7, which is adjoined by the peripheral portions 11, 12 anchored relative to the peripheral regions 5 and 6; the peripheral portions each include a land 13, 14 penetrating the breach 8, 9 and, coinciding with the breach 8, 9, covering parts 15, 16 and 17, 18, respectively. The covering parts 15, 16 and 17, 18 connected via the respective lands 13 and 14 are each located opposite one another relative to the respective housing part 2 and 3, and the covering parts 15 and 17 are lateral extensions of the middle portion 10, so that in plan view, as seen in FIG. 2, the connecting element 4 is seen as strips that cover both the gap 7 and the peripheral regions 5, 6. The covering parts 16, 18 opposite it relative to the housing parts 2, 3 are embodied as mushroom-shaped top parts that are radially widened compared to the respective land 13, 14, so that each striplike, continuous covering part 15 and 17, respectively, are embodied as individual coverings for the top parts, formed by the covering parts 16 and 18, respectively, that are opposite the respective breaches 8 and 9.

The exemplary embodiment of FIG. 3 has a design essentially corresponding to that of FIG. 1, so that with reference to FIG. 1 the reference numerals there are used here as well.

In a departure from FIG. 1, however, the covering parts 16 and 18, with the middle portion 10 and the covering parts 15 and 17 adjoining it, are connected not via the respective land 13 and 14 but instead, like the covering parts 15 and 17, are lateral extensions of the middle portion 10. The respective covering parts 15 and 16 on the one hand and 17 and 18 on the other are thus each connected directly to the middle portion 10, which is connected as an elastic connection member, optionally with a diaphragm-like design, in one piece to the covering parts 15 through 18, so that by means of the connecting element 4 in the vicinity of the breaches 8, 9, the result is that the respective wall part 19, 20 of the respective housing part 2 and 3 that comes to rest adjacent to the gap 7 is embraced in clamped fashion. Such an embodiment is practical, particularly given a striplike embodiment of the peripheral portions 11, 12 that form the covering parts 15 through 18, and results in especially stable anchoring of the connecting element 4 with corresponding bracing of the housing parts 2, 3 relative to one another, and this bracing can be easily produced especially by injection molding as a plastic injection-molded connection and is especially suitable for elastic connections as in FIGS. 5 through 7 as well.

The same is correspondingly true for the embodiment of FIG. 4, in which the housing parts 2, 3 in their peripheral regions 5, 6 are likewise surrounded by the connecting element 4, this case with an embodiment of the connecting element 4 in which this element is countersunk in the gap region 7 relative to the housing parts 2, 3, so that a protruding part of the connecting element 4 past the plane defined by the respective housing parts 2, 3 with their top sides 21, 22, is avoided.

While in the embodiments of FIGS. 1 through 3 the housing parts 2, 3 extend toward one another in their peripheral regions 5, 6, and the peripheral regions 5, 6 extend essentially in the same plane with the housing parts 2, 3, in the embodiment of FIG. 4, an angled embodiment of the peripheral regions 5, 6 is provided for. To that end, the housing parts 2, 3 in the peripheral regions 5, 6 are angled transversely to the top sides 21, 22, so that the gap 7 between the housing parts 2, 3 is in the form of a trench, which is bounded laterally by the angled legs 23, 24; in the exemplary embodiment, for improving the form-locking anchoring of the connecting element 4, the legs 23, 24 are embodied as U-shaped angle sections, whose arm 25 angled relative to the top sides 21, 22 changes over into a transverse arm 26, which runs into an arm 27 that is shortened compared to the arm 25 and extends in the same direction as the arm 25. The legs 23, 24 thus form an essentially hooklike profile, which, as shown in the left in FIG. 4, is breached in some portions in the region of the arm 25 extending over to the transverse arm 26, so that once again, the result is breaches 28, 29. In their vicinity of the angled legs 23, 24, the connecting element 4 is embodied as surrounding the legs 23, 24 and penetrating the breaches 28, 29 in lands, which leads to an embodiment that is especially favorable from the standpoint of injection molding and furthermore assures satisfactory form-locking anchoring of the connecting element 4 relative to the housing parts 2, 3, and as in the embodiment of FIG. 3, stable bracing in all load directions is assured, yet without the connecting element 4 fitting over the top sides 21, 22 of the housing parts 2, 3.

FIGS. 5 through 7 show that connecting elements 4, and elastic connections produced via connecting elements 4, between housing parts 2, 3 may be embodied not only as elongated striplike connecting elements 2, 3 as in FIGS. 1 through 4, but also as ring elements, as can be especially practical for disposing one housing part linking into a further housing part. For instance, in FIG. 5, a housing part 32 is shown, which is located surrounding a housing part 33, and for that purpose, a recess 34 is provided—analogously to the gap 7—in the housing part 2 and has an excess size compared to the housing part 33, so that the housing part 33, with the interposition of an annularly designed connecting element 35, can be affixed elastically resiliently relative to the housing part 32. Preferably, the housing part 32 is provided with a carrying and/or guiding part, such as a handhold, handle, or the like, merely indicated here at 36, so that for the housing identified overall by reference numeral 1, a vibration-damping connection of the housing part 33 that bears the carrying and/or guiding part 36 is the result.

In its embodiment, the connecting element 35 corresponds to the connecting element 4 explained in conjunction with FIG. 3, as indicated in FIG. 6 by reference numerals 8, 9 for the breaches in the housing parts 32, 33 and in FIG. 7 by the reference numerals 13, 14 for the lands, and is distinguished from the connecting element 4 by the annular shape. Correspondingly, the connecting element 35 may also be designed as in FIG. 4. For this, see the descriptions thereof.

FIGS. 5 through 7 show that the housing part 33 that bears the carrying and/or guiding part 36 is buttoned into the housing part 32, received in a recess 34.

Within the scope of the invention, however, a connection corresponding to FIG. 5 of the housing parts 32, 33 is also possible if one housing part, for instance the housing part 32, is embodied with a closed wall and by analogy with FIG. 4 is provided with an annular attachment, which in cross section is designed as protruding toward the wall of the housing part, for instance in a manner corresponding to the leg 23 or 24. The housing part forming the handhold 36 can then be buttoned into this annular attachment to the housing part, by the intermediary of a connecting element as in FIG. 4. As a result, there is no weakening of the housing 1 in the vicinity of the housing part 33 that bears the handhold 36.

Overall, the invention thus affords manifold possibilities of connection between housing parts via an elastic connection element, by way of which an elastic connection between housing parts can be produced in form-locking fashion especially by injection molding.

1-13. (canceled)

14. An elastic connection between housing parts of motor-driven power tools, in particular housing parts of electrically powered handheld power tools, comprising:
an elastic connecting element, disposed spanning a gap between the housing parts to corresponding peripheral regions of the housing parts;
at least one of the housing parts included in a peripheral region of the connecting element;
covering parts of an overfitting peripheral portion, that are in coincidence with a breach in the peripheral region of the at least one of the housing parts, wherein the covering parts of the peripheral portion are joined via a land that penetrates the breach.

15. The elastic connection as defined by claim 14, wherein a covering part in coincidence with a respective breach is embodied as a top part associated with a respective land.

16. The elastic connection as defined by claim 14, wherein a covering part in coincidence with a plurality of breaches is embodied as a covering strip associated jointly with a plurality of lands.

17. The elastic connection as defined by claim 15, wherein a covering part in coincidence with a plurality of breaches is embodied as a covering strip associated jointly with a plurality of lands.

18. The elastic connection as defined by claim 14, wherein the connecting element, given a dimensionally rigid embodiment of the peripheral portions, has a flexible middle portion joining these portions in a manner fitting over the gap.

19. The elastic connection as defined by claim 15, wherein the connecting element, given a dimensionally rigid embodiment of the peripheral portions, has a flexible middle portion joining these portions in a manner fitting over the gap.

20. The elastic connection as defined by claim 17, wherein the connecting element, given a dimensionally rigid embodiment of the peripheral portions, has a flexible middle portion joining these portions in a manner fitting over the gap.

21. The elastic connection as defined by claim 18, wherein the middle portion is embodied flexibly in the manner of a diaphragm.

22. The elastic connection as defined by claim 19, wherein the middle portion is embodied flexibly in the manner of a diaphragm.

23. The elastic connection as defined by claim 20, wherein the middle portion is embodied flexibly in the manner of a diaphragm.

24. The elastic connection as defined by claim 14, wherein the breaches in the peripheral regions of the housing parts attached to one another via a connecting element have a same extension direction.

25. The elastic connection as defined by claim 14, wherein the breaches in the peripheral regions of the housing parts attached to one another via a connecting element have different extension directions.

26. The elastic connection as defined by claim 14, wherein the breaches in the peripheral regions of the housing parts attached to one another via a connecting element extend transversely to an extension direction of the connecting element.

27. The elastic connection as defined by claim 14, wherein the breaches in the peripheral regions of the housing parts attached to one another via a connecting element extend in an extension direction of the connecting element.

28. The elastic connection as defined by claim 14, wherein at least one of the housing parts attached to one another via a connecting element comes to an end with its peripheral region in a direction of the peripheral region of another housing part.

29. The elastic connection as defined by claim 14, wherein at least one of the housing parts attached to one another via a connecting element has a peripheral region angled transversely to a plane of the housing part.

30. The elastic connection as defined by claim 23, wherein at least one of the housing parts attached to one another via a connecting element has a peripheral region angled transversely to a plane of the housing part.

31. The elastic connection as defined by claim 29, wherein the breaches are disposed essentially in a leg of the peripheral region, which leg is angled relative to the plane of the housing part.

32. The elastic connection as defined by claim 30, wherein the breaches are disposed essentially in a leg of the peripheral region, which leg is angled relative to the plane of the housing part.

33. The elastic connection as defined by claim 14, wherein the connecting element is formed by an elastomer part, in particular a plastic part, integrally injection-molded onto at least one of the housing parts.
